(19) United States
(12) Patent Application Publication
(10) Pub. No.: US 2019/0376465 A1
(43) Pub. Date: Dec. 12, 2019

(54) INSULATING SLEEVE HAVING AN INSULATING-GAP FOR A CAST CYLINDER HEAD

(71) Applicant: GM Global Technology Operations LLC, Detroit, MI (US)

(72) Inventors: Michele Bilancia, Turin (IT); Giancarlo Cifali, Turin (IT); Francesco Concetto Pesce, Turin (IT); Lorenzo Magro, Turin (IT); Andrea Tripodi, Genoa (IT)

(21) Appl. No.: 16/004,985

(22) Filed: Jun. 11, 2018

(51) Int. Cl. F02F 1/42; B22D 19/00

(52) U.S. Cl. CPC F02F 1/4271; F02F 2200/06; B22D 19/0009

(57) ABSTRACT

A cast cylinder head having a port lined with an insulating sleeve is provided. The insulating sleeve includes an inner sleeve disposed within an outer sleeve defining an insulating gap between the inner sleeve and outer sleeve. The inner sleeve includes an inlet flange surface and an outlet flange surface joined to an inlet flange surface and an outlet flange surface of the outer sleeve, thereby providing a sealed insulating gap. The insulating gap may contain an insulating material or a vacuum. The outer sleeve includes an exterior surface onto which a molten metal is casted to form the cast cylinder. The exterior surface of the outer-sleeve includes a shoulder to fix the insulating sleeve within a fixed predetermined position within the casting.

### INTRODUCTION

The present disclosure relates to a cast cylinder head having an insulated port, and still more particularly to an insulating sleeve having an air-gap for the cast cylinder head.

A cylinder head for an internal combustion engine typically have intake ports for directing a combustion air to the combustion chambers of the internal combustion engine and exhaust ports for directing an exhaust gas out of the combustion chambers. As the exhaust gas exits the combustion chamber and flows through the exhaust ports, the exhaust gas loses a significant amount of heat energy through the cylinder head. A significant amount of heat is loss to the engine cooling system through coolant passageways within the cylinder head. Instead of taxing the engine cooling system, the heat from the exhaust gas could be conserved and put to beneficial use, such as to power a turbocharger and/or increase the operating efficiency of a catalytic converter, which results in lower emissions. Also, by reducing the transfer of heat from the exhaust gases to the cooling system of the engine allows for a lower coolant system load, which results in a smaller radiator and weight savings.

Due to the irregular shapes and non-uniform diameters found throughout the exhaust port, the walls of the exhaust port are typically coated with an insulating ceramic material liner for the purpose of reducing heat lost. The ceramic liner coating provides an insulating layer between the exhaust gas and coolant passages in the cylinder head. Coating the walls of the exhaust port with an insulating ceramic material liner increases the complexity of the manufacturing of the cylinder heads resulting in increased costs.

Thus, while insulating ceramic lined exhaust ports achieve their intended purpose, there still exists a need for less complex alternative for insulating exhaust ports.

### SUMMARY

According to several aspect, a cast cylinder head having an insulating sleeve is disclosed. The cast cylinder head includes a port wall surface defining a port extending from a port inlet to a port outlet and an insulating sleeve lining a segment of the port wall surface. The insulating sleeve includes an outer-sleeve and an inner-sleeve disposed within the inner sleeve. The outer-sleeve includes an exterior surface and an interior surface opposite the exterior surface. The inner-sleeve includes an exterior surface spaced apart from the interior surface of the outer-sleeve thereby defining an insulating gap therebetween.

In an additional aspect of the present disclosure, the exterior surface of the outer-sleeve is complementary to a predetermined shape defined by the segment of the port wall surface that the insulating sleeve is lining.

In another aspect of the present disclosure, the segment of the port wall surface is cast onto the external surface of the outer-sleeve, thereby conforming the segment of the port wall surface to the external surface of the outer-sleeve.

In another aspect of the present disclosure, the interior surface of the outer-sleeve defines a periphery inlet flange surface and a periphery outlet flange surface, the exterior surface of the inner-sleeve defines a periphery inlet flange surface and a periphery outlet flange surface, and the periphery inlet and outlet flange surfaces of the outer-sleeve are joined with the periphery inlet and outlet flange surfaces of the inner-sleeve, respectively.

In another aspect of the present disclosure, the insulating gap of the insulating sleeve is hermetically seal.

In another aspect of the present disclosure, the insulating gap of the insulating sleeve contains an insulating material.

In another aspect of the present disclosure, the external surface of the outer-sleeve defines at least one shoulder and the segment of the port surface is cast onto the shoulder thereby fixing the insulation sleeve in a predetermined position.

In another aspect of the present disclosure, at least one of the outer-sleeve and inner-sleeve includes a first halve sleeve joined to a second halve-sleeve.

In another aspect of the present disclosure, the inner-sleeve includes a material that suitable to withstand the temperature and corrosivity of an exhaust gas from an internal combustion engine.

In another aspect of the present disclosure, at least one of the interior surface of the outer-sleeve and the exterior surface of the inner sleeve is coated with a ceramic insulating material.

In an additional aspect of the present disclosure, an insulating sleeve for a port line of a cylinder head is disclosed. The insulating sleeve includes an outer-sleeve having an interior surface defining a periphery inlet flange surface and a periphery outlet flange surface and an inner-sleeve having an exterior surface defines a periphery inlet flange surface and a periphery outlet flange surface. The inner-sleeve is disposed within the outer-sleeve such that a portion of the exterior surface of the inner-sleeve is spaced from a portion of the interior surface of the outer-sleeve defining an insulating gap therebetween. The periphery inlet flange surface of the inner-sleeve is joined to the periphery inlet flange surface of the outer-sleeve and the periphery outlet flange surface of the inner-sleeve is joined to the periphery outlet flange surface of the outer-sleeve.

In an additional aspect of the present disclosure, the insulating gap is hermetically sealed.

In another aspect of the present disclosure, the insulating gap contains a vacuum or an insulating material.

In another aspect of the present disclosure, the outer-sleeve includes an exterior surface opposite of the interior surface, wherein the exterior surface defines a shoulder proximal to the inlet flange surface or outlet flange surface.

In another aspect of the present disclosure, at least one of the outer-sleeve and inner-sleeve includes a first halve sleeve and a second halve sleeve.

According to several aspects, a method of making a cast cylinder head having a cast-in insulating sleeve is disclosed. The method includes the steps of providing a cylinder head mold having a form core defining a port, assembling an insulating sleeve onto the form core defining the port, and filling the cylinder head mold with a molten metal.

In an additional aspect of the present disclosure, the step of assembling the insulating sleeve includes disposing an outer-sleeve over an inner-sleeve defining a hermetically sealed gap therebetween.

In another aspect of the present disclosure, the method further includes the step of flowing the molten metal to encapsulate an outer surface of the insulating sleeve.

In another aspect of the present disclosure, the outer surface of the insulating sleeve defines at least one shoulder. The molten metal encapsulate the at least one shoulder.

In another aspect of the present disclosure, the insulating sleeve includes an internal surface in continuous contact with the form core defining the port such that the molten metal does not contact the internal surface.

Further areas of applicability will become apparent from the description provided herein. It should be understood that the description and specific examples are intended for purposes of illustration only and are not intended to limit the scope of the present disclosure.

### BRIEF DESCRIPTION OF THE DRAWINGS

The drawings described herein are for illustration purposes only and are not intended to limit the scope of the present disclosure in any way.

FIG. 1 is a schematic cross-sectional view of a cylinder head having an insulating sleeve in a discharge port connected to a turbocharger, according to an exemplary embodiment;

FIG. 2 is a diagrammatic perspective view of a portion of a cast cylinder head having an insulating sleeve, according to an exemplary embodiment;

FIG. 3 is an explode view of the insulating sleeve of FIG. 2 disposed about a form core defining the exhaust port, according to an exemplary embodiment; and

FIG. 4 is a cross-sectional view of the cast cylinder head of FIG. 2 across line 4-4, according to an exemplary embodiment.

### DETAILED DESCRIPTION

The following description is merely exemplary in nature and is not intended to limit the present disclosure, application, or uses. The illustrated embodiments are disclosed with reference to the drawings, wherein like numerals indicate corresponding parts throughout the several drawings. The figures are not necessarily to scale and some features may be exaggerated or minimized to show details of particular features. The specific structural and functional details disclosed are not to be interpreted as limiting, but as a representative basis for teaching one skilled in the art as to how to practice the disclosed concepts.

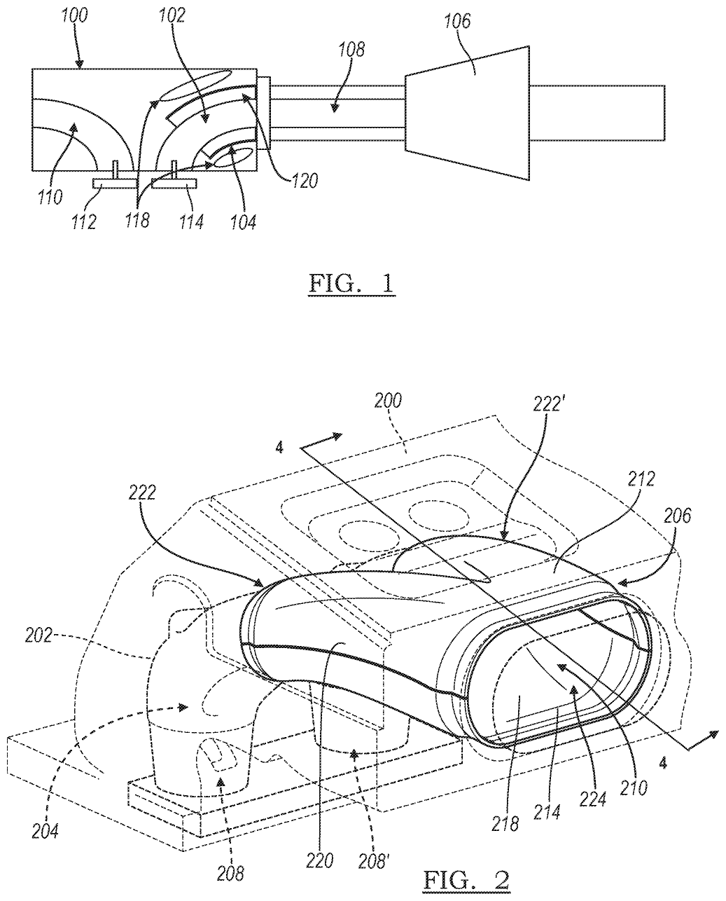

FIG. 1 shows a schematic illustration of a cross-section of an exemplary cast cylinder head 100 having an exhaust port 102 lined with an insulating sleeve 104 for an internal combustion engine. The exhaust port 102 is shown in fluid communication with a turbocharger 106 through an intermediate exhaust manifold 108. The cylinder head 100 is configured to be mounted onto an engine block (not shown) having an open end combustion cylinder. The cylinder head 100 cooperates with the engine block to close the open end of the combustion cylinder, thereby defining an enclosed combustion chamber (not shown). The cylinder head 100 includes an intake port 110 for directing combustion air into the combustion chamber and the exhaust port 102 for directing combusted air, or exhaust gas, out of the combustion chamber. The intake port 110 is selectively opened and closed by an intake poppet valve 112. Similarly, the exhaust port 102 is selectively opened and closed by an exhaust poppet valve 114.

During normal operating conditions of the internal combustion engine, the intake poppet valve 112 is opened to allow combustion air to be drawn into the combustion chamber. Fuel may be introduced to the combustion air prior to the combustion air entering the combustion chamber or introduced directly into the combustion chamber to form a combustible air-fuel mixture. The intake poppet valve 112 is then closed and the air-fuel mixture is combusted within the combustion chamber forming a hot exhaust gas. The exhaust poppet valve 114 is opened to discharge the hot exhaust gas through the exhaust port 102. The hot exhaust gas exiting the exhaust port 102 is directed to the turbocharger 106 and/or catalytic converter (not shown) through the exhaust manifold 108. Heat energy in the exhaust gas is captured and put to beneficial use by the turbocharger 106 to increase the power output of the internal combustion engine. Therefore, it is desirable for the exhaust gas to retain as much heat as feasible before leaving the cylinder head 100 in order to provide sufficient heat energy to the turbocharger 106.

The cylinder head 100 includes internal coolant passageways 118 through which a coolant is circulated when the engine is operating. The circulating coolant removes heat energy from the engine to maintain a normal operating temperature range and to prevent the engine from overheating. Due to the proximity of the coolant passageways 118 to the exhaust port 102, the circulating coolant scavenges heat energy from the hot exhaust gas, thereby lowering the temperature of the exhaust gas prior to the exhaust gas exiting the cylinder head 100. The insulating sleeve 104 is provided in the exhaust port 102 to insulate the exhaust gas from heat loss to the circulating coolant and from conduction through the cylinder head 100 to the ambient air. The insulating sleeve 104 defines an insulating gap 120 between the exhaust port 102 and the coolant passageway 118.

While the exemplary cylinder head 100 is shown with only one exhaust port 102 and one intake port 110, it should be understood that the cylinder head 100 may include a plurality of both exhaust and intake ports 102, 110. Also, the cylinder head 100 may come in many different sizes and shapes and may be configured to cover alternative shaped combustion chambers other than cylindrical shaped. It should be appreciated that the insulating sleeve 104 is not limited for use in the exhaust ports 102. There are also instances where it may be desirable to insulate the intake ports 110 in a cylinder head 100 such as for reducing undesirable heating of the combustion air during the intake process. Lower intake combustion air temperatures improves emission, knock tolerance, and improves air charge density.

FIG. 2 shows a portion of a cast cylinder head, generally indicated by reference 200 having an internal exhaust port wall surface 202 defining an exhaust port 204 for directing exhaust gases from two separate combustion chambers (not shown) to an exhaust manifold (not shown). A portion, or segment, of the exhaust port 204 is lined with an insulating sleeve, which is generally indicated by reference number 206. The cylinder head 200 is shown in phantom lines for clarity of illustration and description of the insulating sleeve 206, which is cast-in the cylinder head 200. The exhaust port wall surface 202 defines the exhaust port 204 extending from a first port inlet 208 in selective fluid communication with a first combustion chamber and a second port inlet 208′ in selective fluid communication with a second combustion chamber to a port outlet 210 in fluid communication with the exhaust manifold. It should be noted that the shapes of the cylinder head 200, exhaust port 204, and insulating sleeve 206 are not meant to be limited as illustrated.

The insulating sleeve 206 lining a segment of the exhaust port 204 is formed of an outer-sleeve 212 joined to an inner-sleeve 214 defining an insulating gap 216 therebetween, which is best shown in FIG. 4. FIG. 4 shows a cross-section of cylinder head 200 having the insulating sleeve 206 of FIG. 2 across line 4-4. The outer-sleeve 212 and inner-sleeve 214 may be stamped or formed from a sheet of material that is suitable to withstand the temperature and corrosive effects of the hot exhaust gas exiting from an internal combustion engine, as well as withstand the elevated temperature of the molten alloy that that is used to cast the cylinder head 200. The material may include stainless steel, aluminum, or copper, or a composite material. The insulating sleeve may also be manufactured by additive manufacturing technique such as 3-D printing.

Still referring to FIG. 4, the inner-sleeve 214 includes an interior surface 218 continuing the exhaust port 204. The outer-sleeve 212 includes an exterior surface 220 that intimately conforms to the irregular shape of the port wall surface 202. The conformity of the exterior surface 220 of the outer-sleeve 212 to the exhaust port wall surface 202 is enabled by casting the cylinder head 200 onto the exterior surface 220 of an assembled insulating sleeve 206. The process of which is disclosed in detail below. The exterior surface 220 of the outer-sleeve 212 includes a textured surface or projections, onto which the molten metal is poured onto and cooled to harden. The texture surface and/or projections cooperates with the harden metal to retain the insulating sleeve 206 in a predetermined position once the molten metal is cooled and hardened. Shoulders 254, 256 may be defined in the outer-sleeve 212 onto which the molten metal is cast.

Referring back to FIG. 2, the embodiment of the insulating sleeve 206 shown includes two sleeve inlets 222, 222′ corresponding to the two port inlets 208, 208′ and one sleeve outlet 224 corresponding to the port outlet 210. In an alternative embodiment, the cylinder head 200 may define one exhaust port outlet 210 for each combustion chamber, therefore the insulating sleeve 206 would include only one sleeve inlet 222 and sleeve outlet 224.

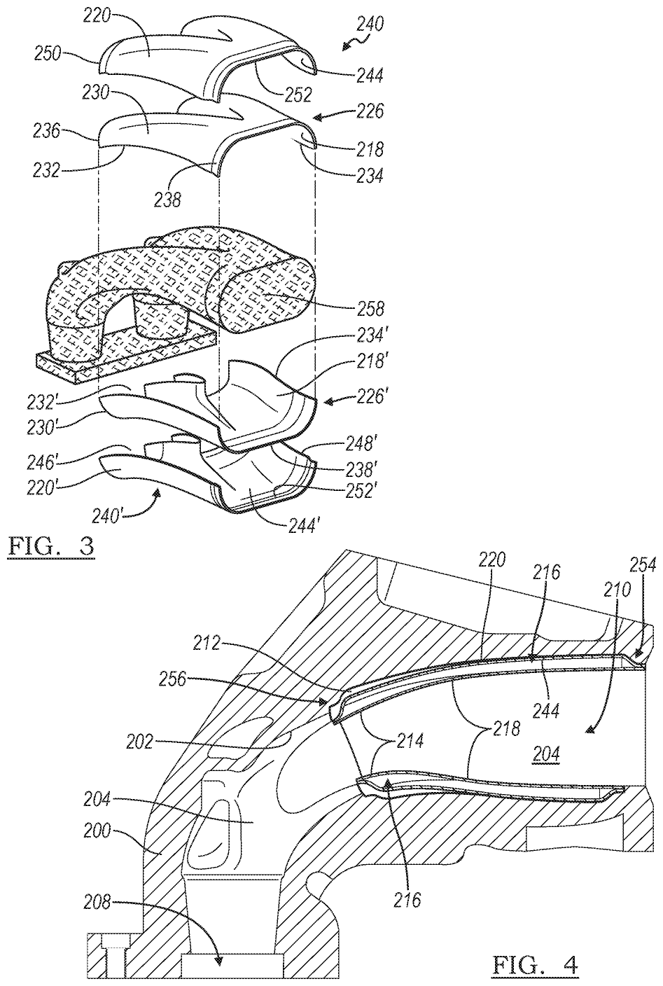

FIG. 3 shows an exploded view of the insulating sleeve 206 of FIG. 2. The inner-sleeve 214 of the insulating sleeve 206 includes an upper first halve 226 and lower second halve 226′. The upper first halve 226 includes an interior surface 218, an exterior surface 230 opposite of the interior surface 218, and two edge surfaces 232, 234 connecting the exterior surface 230 to the interior surface 218. Similarly, the lower second halve 226′ includes an interior surface 218′, an exterior surface 230′ opposite of the interior surface 218′, and two edge surfaces 232′, 234′ connecting the interior surface 218′ to the exterior surface 230′.

The exterior surface 230, 230′ of each of the first and second halves 226, 226′ defines a inlet flange surface 236, 236′ and an outlet flange surface 238, 238′, wherein each of the flange surfaces 236, 236′, 238, 238′ extends to the corresponding two edge surfaces 232, 234, 232′, 334′. The first halve 226 is joined to the second halve 226′ to form the inner-sleeve 214. The joining surfaces 232, 234, 232′, 234′ may be brazed, welded, or epoxied to provide a single integral piece inner-sleeve 214 having a periphery inlet flange surface 236, 236′ and periphery outlet flange surface 238, 238′.

The outer-sleeve 212 of the insulating sleeve 206 includes an upper first halve 240 and lower second halve 240′. The upper first halve 240 includes an exterior surface 220, an interior surface 244 opposite of the exterior surface 220, and two edge surfaces 246, 248 connecting the exterior surface 220 to the interior surface 244. Similarly, the lower second halve includes an exterior surface 220′, an interior surface opposite 244′ of the exterior surface 220′, and two edge surfaces 246′, 248′ connecting the interior surface 244 to the exterior surface 240.

The interior surface 244, 244′ of each of the first and second halves 240, 240′ defines an inlet flange surface 250, 250′ and an outlet flange surface 252, 252′ wherein each of the flange surfaces 250, 250′, 252, 252′ extends to the two edge 246, 248, 246′, 248′. The first halve 240 is joined to the second halve 240′ to form the outer-sleeve 212. The joining surfaces 246, 248, 246′, 248′ may be brazed, welded, or epoxied to provide a single integral piece outer-sleeve 212 having a periphery inlet flange surface 250, 250′ and periphery outlet flange surface 252, 252″.

The first and second halves 240, 240′ of the outer-sleeve 212 are fitted over the assembled inner-sleeve 214 such that the interior surfaces 244, 244′ of the outer-sleeve 212 are facing the exterior surfaces 230, 230′ of the inner-sleeve 214. The insulating gap 216 is defined between the interior surfaces 244, 244′ of the outer-sleeve 212 and the respective exterior surfaces 230, 230′ of the inner-sleeve 214. The periphery inlet flange surfaces 250, 250 ‘of the outer-sleeve 212 sealingly join the periphery inlet flange surface 236, 236’ of the inner-sleeve 214, the periphery outlet flange surface 252, 252′ of the outer-sleeve 212 sealingly join the periphery outlet flange surface 238, 238′ of the inner-sleeve 214, and the two edges surfaces 246, 248 of the outer-sleeve are sealing joined to the other two edge surfaces 246′, 248′. The joining surfaces between the outer-sleeve 212 and inner-sleeve 214 may be joined by brazing, welding, or epoxying to join the outer-sleeve 212 to the inner-sleeve 214 to define a hermetically sealed insulating gap 216 between the outer-sleeve 212 and the inner-sleeve 214. While a hermetic seal is desirable, the insulating gap 216 may also be non-hermetically sealed.

Referring back to FIG. 4, the outer-sleeve 212 is joined to the inner-sleeve 214 to define an insulating gap 216 therebetween. The assembly of the outer-sleeve 212 to inner-sleeve 214 may be completed in a vacuum condition such that the insulating gap 216 is void of air to improve insulation, if the insulating gap 216 is to be hermetically sealed. The exterior surfaces 230, 230′ of the inner-sleeve 214 and the interior surfaces 244, 244′ of the outer-sleeve 212 may be coated with an insulating material such as ceramic material to provide additional insulation. Alternatively, the insulating gap 216 may be filled with an insulating gas or a foam material having suitable insulating properties.

The cylinder head 200 may be manufactured by a metal casting process such as die casting, semi-permanent mold, and low pressure casting. The process includes providing a cylinder head mold having a solid form core 258 defining the empty space of the exhaust port 204. The form core 258 is compacted of a chemically treated sand, such as silica, zircon, fused silica, and others that is suitable for cast molding defining the empty space of the exhaust port 204. The insulating sleeve 206 is assembled onto the solid form core 258. The interior surface 218 of the insulating sleeve 206 is in intimate contact with the solid form core 258.

The mold is then filled with a molten metal such as an aluminum alloy or an iron alloy. The molten metal flows onto and encapsulates the exterior surface 220, 220′ of the insulating sleeve 206. The mold is allowed to cool and the molten metal solidifies onto the exterior surface 220, 220′ of the insulating sleeve 206 such that the insulating sleeve 206 is an integral part of the cylinder head 200. The cylinder head 200 is removed from the mold and the exhaust port form core 258 is removed, thereby exposing the interior surface 218 of the inner-sleeve 214 and the portion of the exhaust port surface not lined by the insulating sleeve 206. The casted cylinder head 200 is cleaned and machined to predetermined specifications.

A benefit of the insulating sleeve 206 is that it provides insulation to retain the heat in the exhaust gas prior to existing the cylinder head 200. A benefit of the casting process is that the portion of the exhaust port wall that is lined with the insulating sleeve 206 conforms to the insulating sleeve 206 as opposed to the insulating sleeve 206 conforming to the exhaust port wall. Another benefit of the insulating sleeve 206 is that the features defined by the exterior surface 220 of the outer-sleeve 212 cooperates with the harden casting to retain the insulating sleeve 206 within a predetermined position within the cylinder head 200. Yet still another benefit, is that the casted cylinder head 200 encapsulates a portion of the exterior surface 220 of the insulating sleeve 206 such that the insulating sleeve 206 and casting behaves as a single integral structure. These are only a few examples of benefits provided with the disclosure of the cylinder head 200 having the insulating sleeve 206 as described.

While an insulating sleeve 206 for an exhaust port is disclosed, the insulating sleeve 206 may be used to line an air intake port. There are instances where it may be desirable to insulate the intake ports in a cylinder head 200 such as for reducing undesirable heating of the combustion air during the intake process. Lower combustion air temperature improves emissions, knock tolerance, and improves air charge density. The insulating sleeve 206 provides an insulating air gap 216 as an insulation barrier for maintaining the elevated temperature of the exhaust gas for an exhaust port, or for reducing undesirable charge air heating of the incoming air for combustion for an intake port.

The description of the present disclosure is merely exemplary in nature and variations that do not depart from the gist of the present disclosure are intended to be within the scope of the present disclosure. Such variations are not to be regarded as a departure from the spirit and scope of the present disclosure.

1. A cast cylinder head, comprising:
a port wall surface defining a port extending from a port inlet to a port outlet; and
an insulating sleeve lining a segment of the port wall surface, wherein the insulating sleeve includes an outer-sleeve and an inner-sleeve disposed within the outer-sleeve;
wherein the outer-sleeve includes an exterior surface and an interior surface opposite the exterior surface, and
wherein the inner-sleeve includes an exterior surface spaced apart from the interior surface of the outer-sleeve thereby defining an insulating gap therebetween.

2. The cast cylinder head of claim 1, wherein the exterior surface of the outer-sleeve is complementary to a predetermined shape defined by the segment of the port wall surface that the insulating sleeve is lining.

3. The cast cylinder head of claim 1, wherein the segment of the port wall surface is cast onto the external surface of the outer-sleeve, thereby conforming the segment of the port wall surface to the external surface of the outer-sleeve.

4. The cast cylinder head of claim 3,
wherein the interior surface of the outer-sleeve defines a periphery inlet flange surface and a periphery outlet flange surface;
wherein the exterior surface of the inner-sleeve defines a periphery inlet flange surface and a periphery outlet flange surface; and
wherein the periphery inlet and outlet flange surfaces of the outer-sleeve are joined with the periphery inlet and outlet flange surfaces of the inner-sleeve, respectively.

5. The cast cylinder head of claim 4, wherein the insulating gap of the insulating sleeve is hermetically seal.

6. The cast cylinder head of claim 4, wherein the insulating gap of the insulating sleeve contains an insulating material.

7. The cast cylinder head of claim 4, wherein the external surface of the outer-sleeve defines at least one shoulder, and wherein the segment of the port surface is cast onto the shoulder thereby fixing the insulation sleeve in a predetermined position.

8. The cast cylinder head of claim 4, wherein at least one of the outer-sleeve and inner-sleeve includes a first halve sleeve joined to a second halve-sleeve.

9. The cast cylinder head of claim 4, wherein the inner-sleeve includes a material that suitable to withstand the temperature and corrosivity of an exhaust gas from an internal combustion engine.

10. The cast cylinder head of claim 4, wherein at least one of the interior surface of the outer-sleeve and the exterior surface of the inner sleeve is coated with a ceramic insulating material.

11. An insulating sleeve for a port line of a cylinder head, comprising:
an outer-sleeve having an interior surface defining a periphery inlet flange surface and a periphery outlet flange surface;
an inner-sleeve having an exterior surface defines a periphery inlet flange surface and a periphery outlet flange surface;
wherein in the inner-sleeve is disposed within the outer-sleeve such that a portion of the exterior surface of the inner-sleeve is spaced from a portion of the interior surface of the outer-sleeve defining an insulating gap therebetween,
wherein the periphery inlet flange surface of the inner-sleeve is joined to the periphery inlet flange surface of the outer-sleeve, and
wherein the periphery outlet flange surface of the inner-sleeve is joined to the periphery outlet flange surface of the outer-sleeve.

12. The insulating sleeve of claim 11, wherein the insulating gap is hermetically sealed.

13. The insulating sleeve of claim 11, wherein the insulating gap contains a vacuum or an insulating material.

14. The insulating sleeve of claim 13, wherein the outer-sleeve includes an exterior surface opposite of the interior surface, wherein the exterior surface defines a shoulder proximal to the inlet flange surface or outlet flange surface.

15. The insulating sleeve of claim 14, wherein at least one of the outer-sleeve and inner-sleeve includes a first halve sleeve and a second halve sleeve.

16. (canceled)

17. A method of making a cast cylinder head having a cast-in insulating sleeve, comprising the steps of:
providing a cylinder head mold having a form core defining a port;
assembling an insulating sleeve onto the form core defining the port; and
filling the cylinder head mold with a molten metal;
wherein the step of assembling the insulating sleeve includes disposing an outer-sleeve over an inner-sleeve defining an insulating gap therebetween.

18. The method of claim 16, further comprising the step of flowing the molten metal to encapsulate an outer surface of the insulating sleeve.

19. The method of claim 17, wherein the outer surface of the insulating sleeve defines at least one shoulder, and wherein the molten metal encapsulate the at least one shoulder.

20. The method claim 17, wherein the insulating sleeve includes an internal surface in continuous contact with the form core defining the port such that the molten metal does not contact the internal surface.
